(19) United States
(12) Patent Application Publication
(10) Pub. No.: US 2025/0084510 A1
(43) Pub. Date: Mar. 13, 2025

(54) LIQUID PHASE SINTERED ALUMINUM ALLOY FOR BINDER JET PRINTING

(71) Applicants: Ford Global Technologies, LLC, Dearborn, MI (US); The University of Western Australia, Crawley (AU); The University of Melbourne, Melbourne (AU)

(72) Inventors: Graham Schaffer, Melbourne (AU); Tim Sercombe, Crawley (AU); Tesfaye Molla, Melbourne (AU); Yang Huo, Canton, MI (US); Mei LI, Bloomfield Hills, MI (US); Mark Meinhart, Dexter, MI (US); John Cornell, Allenton, MI (US); Ampaiphan Atthapreyangkul, Melbourne (AU); Jincheng Wang, Crawley (AU); Andrew Youssef, Crawley (AU); Sean Oakley, Crawley (AU); Joss Doak-Smith, Crawley (AU)

(73) Assignees: Ford Global Technologies, LLC, Dearborn, MI (US); The University of Western Australia, Crawley (AU); The University of Melbourne, Melbourne (AU)

(21) Appl. No.: 18/462,923

(22) Filed: Sep. 7, 2023

(51) Int. Cl. C22C 21/06; B22F 3/10; B33Y 70/00; C22C 1/04

(52) U.S. Cl. CPC C22C 21/06; B22F 3/1007; B22F 3/1021; B22F 3/1035; B33Y 70/00; C22C 1/0416; B22F 2201/02; B22F 2301/052; B22F 2301/058; B22F 2301/30; B22F 2998/10; B22F 2999/00

(57) ABSTRACT

An alloy includes a mixture of aluminum, tin and magnesium. An amount of the magnesium is between about 2.5% and 6.5% by weight of the mixture. The alloy is binder jet printed and liquid phase sintered.

### FIELD

The present disclosure relates to additive manufacturing. More specifically, the present disclosure relates to an aluminum alloy for additive manufacturing with binder jet printing.

### BACKGROUND

The statements in this section merely provide background information related to the present disclosure and may not constitute prior art.

Binder jet printing is an effective additive manufacturing method for high-volume industry production to fabricate net-shape metal structures with complex geometry and integrated functions. The objects printed by this technology, namely green bodies, require debinding and densification processes to form fully dense final parts. In some applications, sintering is utilized in the densification for certain metal powders, which is capable of producing uniform shrinkages and material bonds with desired strengths. Unlike other metal powders, however, aluminum powders are difficult to process into a fully dense state via sintering because of the high reactive surface condition resulting in the formation of stable oxidation layers.

Accordingly, additional treatments or processes are often used to enable sintering of aluminum powder materials for additive manufacturing, which adds to manufacturing cycle time.

These issues related to binder jet printing of aluminum and aluminum alloy powders are addressed by the present disclosure.

### SUMMARY

This section provides a general summary of the disclosure and is not a comprehensive disclosure of its full scope or all of its features.

In one form of the present disclosure, an alloy includes a mixture of aluminum, tin and magnesium. An amount of magnesium is between about 2.5% and 6.5% by weight of the mixture. The alloy is binder jet printed and liquid phase sintered.

In variations of this alloy, which may be implemented individually or in any combination: the magnesium, the aluminum and the tin are in the form of an alloy powder; the magnesium, the aluminum and the tin are mixed together to form a powder mixture; the magnesium, the aluminum and the tin are combined in any combination of alloy and elemental powders; the amount magnesium is between about 2.5% to 4% by weight of the mixture; an amount of tin is about 1% by weight of the mixture; full densification of the alloy is achieved for a liquid phase fraction greater than about 8%; the liquid phase fraction is between about 8% and 20%; and the aluminum is an alloy of aluminum.

In another form of the present disclosure a method to form an alloy for binder jet printing includes mixing aluminum, tin, and magnesium to form a mixture. An amount of magnesium is between about 2.5% to 6.5% by weight of the mixture. The mixture is selectively combined with a binder to form a shape, the mixture is debinded, and the mixture is liquid phase sintered.

In variations of this method, which may be implemented individually or in any combination: the method further comprises holding the mixture at about 500° C. between debinding and liquid phase sintering; the magnesium, the aluminum and the tin are in the form of an alloy powder; the magnesium, the aluminum and the tin are mixed together to form a powder mixture; the magnesium, the aluminum and the tin are combined in any combination of alloy and elemental powders; the amount of magnesium is between about 2.5% to 4% by weight of the mixture; an amount of tin is about 1% by weight of the mixture; full densification of the alloy is achieved for a liquid phase fraction greater than about 8%; and the aluminum powder is an alloy of aluminum.

In yet another form, an alloy includes a mixture of aluminum, tin and magnesium. An amount of tin is about 1% by weight of the mixture and an amount of magnesium is between about 2.5% to 6.5% by weight of the mixture, and wherein the remainder of the mixture is aluminum. The alloy is binder jet printed and liquid phase sintered.

In another variation of this alloy, the magnesium, the aluminum and the tin are combined in any combination of alloy and elemental powders.

Further areas of applicability will become apparent from the description provided herein. It should be understood that the description and specific examples are intended for purposes of illustration only and are not intended to limit the scope of the present disclosure.

### DRAWINGS

In order that the disclosure may be well understood, there will now be described various forms thereof, given by way of example, reference being made to the accompanying drawings, in which:

FIG. 1 shows experimentally measured density vs liquid phase fraction/sintering temperature curves for four powder materials showing the full densities can be achieve only if >10% liquid phase fraction is produced during LPS in accordance with the teachings of the present disclosure;

FIG. 2 is a side view of selected samples with pre-alloying of 1 wt % tin and 4 wt % magnesium powders in shown in FIG. 1 illustrating that the full densities and acceptable dimensional accuracy is achieve for the samples sintered with 10-20 liquid phase fraction in accordance with the teachings of the present disclosure;

FIG. 3 shows photographs and densities of the final bodies sintered at ˜20% liquid phase fraction illustrating that pre-alloying of 4 wt % Mg powder increases the final densities and enhances the dimensional accuracy for three Al powder materials in accordance with the teachings of the present disclosure;

FIG. 4 shows experimentally measured density vs liquid phase fraction/sintering temperature curves for Al-1 wt % Sn systems with various amounts of Mg illustrating the liquid phase fractions to achieve the plateaus of a fully dense state increase with increasing amounts of Mg in accordance with the teachings of the present disclosure;

FIG. 5 shows photographs of representative microstructures of liquid phase sintered samples illustrating the formation of skeleton structures if a holding stage is utilized in accordance with the teachings of the present disclosure;

FIG. 6 shows contours of liquid phase sintered Al-5 Mg-1Sn samples illustrating that dimensional stability enhances by the utilization of a holding stage in accordance with the teachings of the present disclosure; and

FIG. 7 is a flow diagram of a process to make aluminum parts in accordance with the teachings of the present disclosure.

The drawings described herein are for illustration purposes only and are not intended to limit the scope of the present disclosure in any way.

### DETAILED DESCRIPTION

The following description is merely exemplary in nature and is not intended to limit the present disclosure, application, or uses. It should be understood that throughout the drawings, corresponding reference numerals indicate like or corresponding parts and features.

In the sintering of aluminum alloys, the presence of magnesium is important to the rupture of the surface oxides that form on the aluminum powder. Further, sintering at a temperature between the solidus and liquidus temperatures, that is, liquid phase sintering (LPS), enables the densification process for aluminum green bodies. The increase in the volume of a liquid phase, however, reduces dimensional accuracy of the part. As a result, the liquid phase fraction for LPS of aluminum powder materials is well controlled within certain ranges to enable densification while maintaining dimensional accuracy. Meanwhile, the formation of the nitride layers around aluminum powder is also desired for LPS of aluminum powder materials because the nitride layers can form skeleton structures, which increase dimensional stability.

Based on the understanding of LPS as described above, the inventors have discovered several design factors for LPS of aluminum powder materials in order to enhance the sintering of aluminum powder materials. First, magnesium is an important element since it can disrupt the oxide layers; second, tin exists with aluminum powder, either as a separate powder or an alloying element into the Al powder, because it is able to reduce the growth rate of the nitride layers; third, a nitrogen sintering atmosphere transforms the oxidation layers to the nitride layer; and, further, a sintering temperature is selected to ensure that the sintering occurs with the desired liquid phase fraction.

Some aluminum powder materials, such as alloy 6061, can be sintered to final bodies with full densities and reasonable dimensional accuracy by including the described experimental factors. In previous studies, LPS of aluminum powder material was found to be too delicate to be compatible with high-volume industry production because non-uniform temperature distribution and gas flow always exist in industry sintering furnaces. This occurs for binder jetting printed aluminum green bodies because no compaction step can be utilized to introduce plastic deformation to break the oxide layers or to increase contact areas between particles to facilitate diffusion. In addition, the binder jetting printed objects have complex geometric features. Thus, uniform shrinkage is desired to provide high dimensional stability during LPS.

In accordance with teachings of the present disclosure, a demonstrated method to enhance the manufacturing robustness of LPS for the binder jetting printed aluminum green bodies is provided. One form of the present disclosure provides three primary components as described in detail below.

For the first component, the liquid phase fraction of liquid phase sintered aluminum powder materials is selected within 8-20% to provide an efficient densification process and acceptable dimensional accuracy. For example, four commercially available aluminum powders including pure aluminum, 201, 6061, and 7075, were mixed with 1 wt % tin powder and 4 wt % magnesium powder. As stated above, the addition of tin and magnesium are important factors to enable LPS of aluminum powders. Utilization of 4 wt % magnesium is discussed in detail below. After pre-mixing, the powder materials were then made into cylinder green bodies for subsequent sintering. The sintering processes include a debinding stage to remove the binder, an intermediate holding stage to form nitride rigid skeleton structures, which is discussed below in the third component, and a final sintering stage for densification. The sintering temperatures for the final densification stage were selected to achieve different liquid fractions.

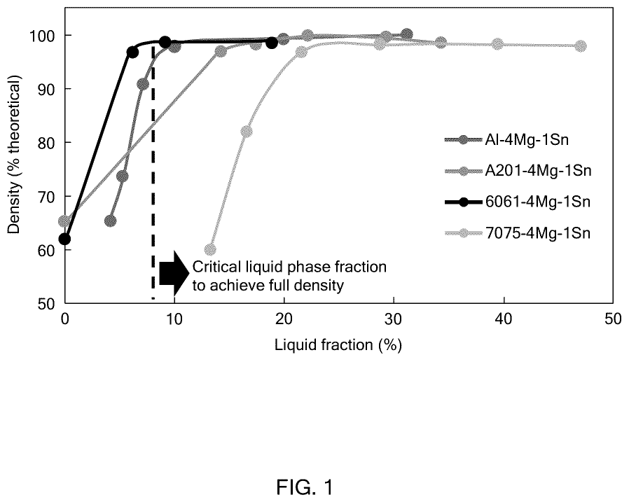

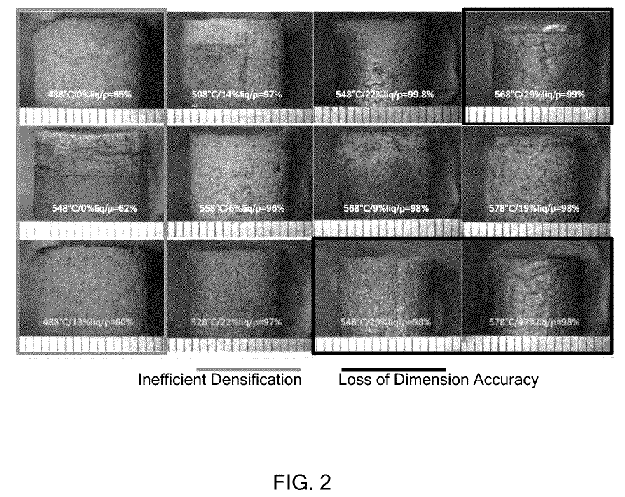

Referring to FIG. 1, the final densities of four powder materials were measured and plotted vs the corresponding liquid phase fractions. As shown by the dotted line in FIG. 1, if about 8% liquid phase is produced during LPS, then full density can be achieved for the four powder materials. Specifically, full densities are achieved if >10% liquid phase fraction is produced during LPS. Once the liquid phase fractions are above 20%, however, it is possible to lose dimensional accuracy for the final bodies, as shown in FIG. 2. Specifically, FIG. 2 illustrate sides views of some selected samples alloyed with 1 wt % tin and 4 wt % magnesium powders, showing that full density and acceptable dimensional accuracy are achieved for the samples sintered with 10-20% liquid phase fraction.

The acceptable dimensional accuracy that the cylinder shape and relatively smooth surface are achieved in all the samples sintered with liquid phase fraction less than 20%. At higher liquid phase fractions, the samples have rough surfaces with dimpling. Hence, the liquid phase fractions of LPS of aluminum powder materials that are selected within 10-20% result in efficient densification process and acceptable dimensional accuracy.

For the second component, the present disclosure provides that alloying with 2.5-4 wt. % magnesium, along with alloying with tin, into commercial aluminum powder materials increases the final densities and enhances dimensional accuracy. For example, three commercially available aluminum powder materials with different amounts of magnesium including 201 (Al—Cu, 0.25 wt % Mg), 6061 (Al—Si—Mg, 1 wt % Mg), and 7075 (Al—Zn—Mg—Cu, 2.5 wt % Mg) were first mixed with 1 wt % tin powder. The mixtures of aluminum powder and tin powder were then made into green bodies for subsequent sintering. (The sintering processes is the same as described previously.) The sintering temperatures for the final densification stage were selected to achieve less than 20% liquid fraction for different aluminum powder and tin powder combinations.

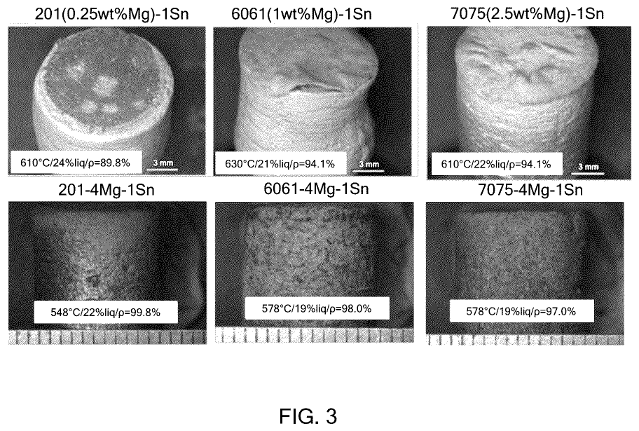

As FIG. 3 shows, densities of the final bodies sintered at about 20% liquid phase fraction by alloying with additional 4 wt % Mg powder can increase the final densities and enhance the dimensional accuracy of the aluminum powders 201, 6061, and 7075. Specifically, the final densities for 201+1 wt % Sn sintered at 610° C. (24 vol % liquid phase), 6061+1 wt % Sn sintered at 630° C. (21 vol % liquid phase), and 7075+1 wt % Sn sintered at and 610° C. (22 vol % liquid phase), are only 89.8%, 94.1%, and 94.1%, respectively, even though more than 20% liquid fractions have been achieved. In addition, the photographs indicate that the final bodies of 201+1 wt % Sn and 6061+1 wt % Sn lose their cylindrical shapes, while 7075+1 wt % Sn exhibits a cylindrical shape but with a top lip that has not shrunk as much as the remaining section. This indicates that increasing the total amount of magnesium above 2.5 wt % can enhance both final densities and dimensional accuracy. As a result, the addition of 4 wt % magnesium powder was added into the mixture of aluminum powder and tin powder materials and made into the same cylindrical shape.

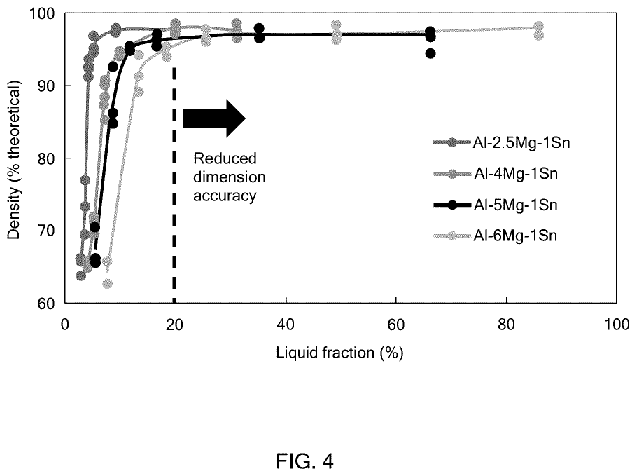

The green bodies were then sintered using the same three-stage sintering processes but with different final sintering temperatures to produce 20% liquid phase fraction, according to the overall compositions after alloying with 4 wt % magnesium powder. (The results are shown in FIG. 1 to compare with the scenarios without alloying with additional magnesium powder) At sintering temperatures that form 20% liquid phase fractions, the samples with 4 wt % magnesium can achieve higher final densities, which are very close to the fully dense state, and uniform shrinkage to maintain a cylindrical shape. In addition, other benefits result from increasing the overall amount of magnesium, including extra solution strengthening. This also indicates, however, that pre-alloying with magnesium powder needs to be maintained below a certain threshold, as supported by the densification curves shown in FIG. 4. Specifically, FIG. 4 shows experimentally measured density vs liquid phase fraction/sintering temperature curves for Al-1 wt % Sn systems with various amounts of Mg illustrating that the liquid phase fractions to achieve the plateaus of fully dense state increase with increasing amounts of Mg.

Further, the final densities for Al+1 wt % Sn powder materials with alloying Mg from between about 2.5 wt % to 6 wt % were measured at different final sintering temperatures are plotted in FIG. 4. Hence, the liquid phase fraction to achieve the fully dense state increases with increasing amounts of magnesium. Accordingly, when the magnesium amount is higher than 5 wt %, the liquid phase fractions to achieve the fully dense state exceeds 20%, at which dimensional accuracy is reduced. Therefore, alloying of magnesium between about 2.5 wt % and 6 wt % can enhance sintering performance for commercial aluminum powder materials in terms of final densities and dimensional stabilities. In certain variations, the amount of Mg is between about 2.5% to 6.5% by weight of the mixture. In some variations, one or more of the aluminum, the tin and the magnesium are in powder form as an elemental powder, that is, a powder form of the individual element. In other variations, one or more of the aluminum, the tin and the magnesium are each in powder form as an alloy powder, that is, the aluminum, the tin and/or the magnesium alloy powder may include other components. In yet other variations, the aluminum, the tin and magnesium are combined together into a powder mixture of the elements or as an alloy powder that may include other components.

It should also be understood that the elemental ranges discussed herein include all incremental values between the minimum element composition and maximum element composition values. That is, a minimum element composition value can range from the minimum value to the maximum value. Likewise, the maximum element composition value can range from the maximum value shown to the minimum value discussed. For example, the minimum Mg content can be 2.5, 2.6, 2.7, 2.8, 2.9, 3.0, 3.1, 3.2, 3.3, 3.4, 3.5, 3.6, 3.7, 3.8, 3.9, 4.0, 4.1, 4.2, 4.3, 4.4, 4.5, 4.6, 4.7, 4.8, 4.9, 5.0, 5.1, 5.2, 5.3, 5.4, 5.5, 5.6, 5.7, 5.8, 5.9, 6.0, 6.1, 6.2, 6.3, 6.4, 6.5, and any value between these incremental values, and the maximum Mg content can be 6.5, 6.4, 6.3, 6.2, 6.1, 6.0, 5.9, 5.8, 5.7, 5.6, 5.5, 5.4, 5.3, 5.2, 5.1, 5.0, 4.9, 4.8, 4.7, 4.6, 4.5, 4.4, 4.3, 4.2, 4.1, 4.0, 3.9, 3.8, 3.7, 3.6, 3.5, 3.4, 3.3, 3.2, 3.1, 3.0, 2.9, 2.8, 2.7, 2.6, 2.5, and any value between these incremental values.

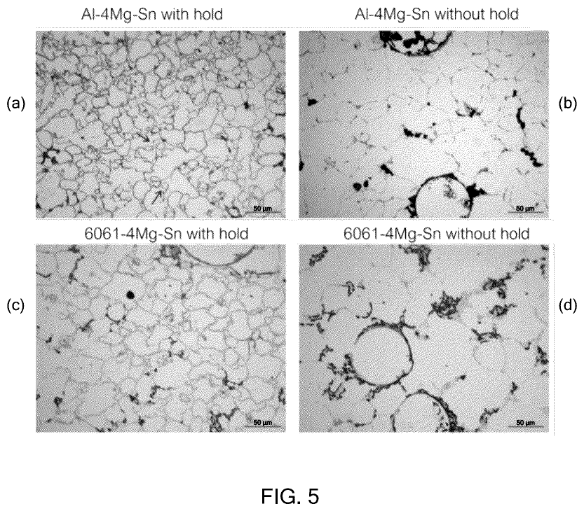

For the third component, the present disclosure provides that an intermediate holding stage between the debinding stage and the final sintering stage can promote the formation of the rigid nitride skeleton structures that enhance dimensional stability of aluminum powder materials. For example, two aluminum powder materials, Al-4 Mg-1Sn and 6061-4 Mg-1Sn, were sintered with two different thermal cycles. The first utilizes the two-stage sintering that only consists of a debinding stage and a sintering stage, while the second includes an additional intermediate holding stage at 500° C. for 60 minutes. FIG. 5 shows a significant difference in the LPS microstructures with and without the intermediate holding stage for both Al-4 Mg-1Sn and 6061-4 Mg-1Sn powder materials. Specifically, FIG. 5 illustrates representative microstructures of the liquid phase sintered samples showing the skeleton structures form if the intermediate holding stage is utilized.

The nitride structures around prior Al grains are shown in the samples with the intermediate holding stage are shown FIGS. 5(a) and 5(c). An energy dispersive spectrometer analysis confirms that these are nitride phases. Removal of the intermediate holding stage results in larger Al grains and much less nitride structure, as shown in FIGS. 5(b) and 5(d). Note that the very dark phases shown in FIG. 3 are identified as Mg₂Sn phases. Hence, the experimental results show that a 3-step thermal cycle that includes an intermediate holding stage promotes the formation of nitride skeleton structures for aluminum powder materials. To further clarify the benefit of the nitride skeleton structures, the contours of the samples after LPS were recorded with a stereomicroscope.

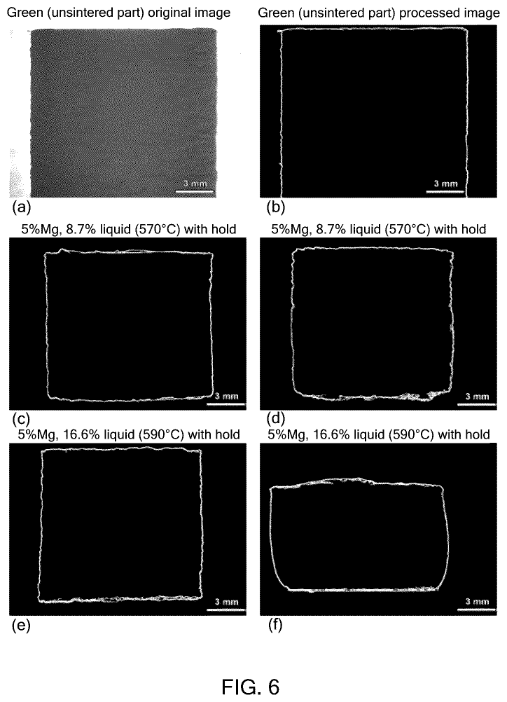

The representative photography for Al-5 Mg-1Sn sample is illustrated in FIG. 6, which illustrates representative photography of the contours of the liquid phase sintered Al-5 Mg-1Sn samples showing that the dimensional stability is enhanced by the intermediate holding stage.

The green part and associated stereomicroscope recorded contour, as shown in FIGS. 6(a) and 6(b), respectively, present a cylinder with sharp, parallel edges. If the liquid fraction at the final sintering stage is below 15%, the sintered samples exhibit uniform shrinkage regardless of whether an intermediate holding stage is utilized, as illustrated in FIGS. 6(c) and 6(d). When the liquid phase is between 15-20%, however, the samples without an intermediate holding stage, no or much less nitride skeleton structures formed, such that a cylinder after LPS is not maintained, as shown in FIG. 6(f). On the other hand, uniform shrinkage is still observed for the samples with the intermediate holding stage, even though>15% liquid phase fraction was formed during LPS, as shown in FIG. 6(e). Therefore, enhanced dimensional stability is a consequence of nitride skeleton structures that is facilitated by the intermediate holding stage. In other words, the 3-stage sintering with an exclusive intermediate holding stage provides dimensional stability but also allows densification, as well as allowing a wider sintering window.

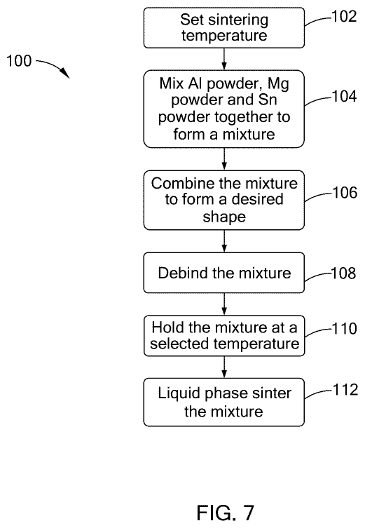

Referring to FIG. 7, there is shown a process 100 that summarizes the above-described steps in the formation of a liquid phase sintered alloy for use in binder jet printing. In a step 102, a sintering temperature is selected to enable densification while maintaining dimensional accuracy. In a step 104, an aluminum powder, a tin powder, and a magnesium powder are mixed together to form a mixture within specified composition ranges to increase sintered bodies' strength, extend LPS performing conditions, and facilitate the formation of nitride layer. In a step 106, the mixture is mixed with a binder to form a shape. In a step 108, the mixture is debinded. In a step 110, a holding stage is utilized between the debinding stage and the sintering stage to further promote the formation of nitride layers as rigid skeleton structures. And in a step 112, the mixture is liquid phase sintered with a nitrogen atmosphere that transforms the oxidation layers to the nitride layer with a sintering temperature that is selected to ensure that the sintering occurs with the desired liquid phase fraction.

Unless otherwise expressly indicated herein, all numerical values indicating mechanical/thermal properties, compositional percentages, dimensions and/or tolerances, or other characteristics are to be understood as modified by the word “about” or “approximately” in describing the scope of the present disclosure. This modification is desired for various reasons including industrial practice, material, manufacturing, and assembly tolerances, and testing capability.

As used herein, the phrase at least one of A, B, and C should be construed to mean a logical (A OR B OR C), using a non-exclusive logical OR, and should not be construed to mean “at least one of A, at least one of B, and at least one of C.”

The description of the disclosure is merely exemplary in nature and, thus, variations that do not depart from the substance of the disclosure are intended to be within the scope of the disclosure. Such variations are not to be regarded as a departure from the spirit and scope of the disclosure.

What is claimed is:

1. An alloy for liquid phase sintering in binder jet printing, the alloy comprising:
a mixture of:
aluminum;
tin; and
magnesium,
wherein an amount of magnesium is between about 2.5% to 6.5% by weight of the mixture.

2. The alloy of claim 1, wherein the magnesium, the aluminum and the tin are in the form of an alloy powder.

3. The alloy of claim 1, wherein the magnesium, the aluminum and the tin are mixed together to form a powder mixture.

4. The alloy of claim 1, wherein the magnesium, the aluminum and the tin are combined in any combination of alloy and elemental powders.

5. The alloy of claim 1, wherein the amount of magnesium is between about 2.5% to 4% by weight of the mixture.

6. The alloy of claim 1, wherein an amount of the tin is about 1% by weight of the mixture.

7. The alloy of claim 1, wherein full densification of the alloy is achieved for a liquid phase fraction greater than about 8%.

8. The alloy of claim 7, wherein the liquid phase fraction is between about 8% and 20%.

9. The alloy of claim 1, wherein the aluminum is an alloy of aluminum.

10. A method to form an alloy for binder jet printing, the method comprising:
mixing:
aluminum;
tin; and
magnesium to form a mixture, wherein an amount of magnesium is between about 2.5% to 6.5% by weight of the mixture;
selectively combining the mixture with a binder to form a shape;
debinding the mixture; and
liquid phase sintering the mixture with nitrogen.

11. The method of claim 10 further comprising holding the mixture at about 500° C. between debinding and liquid phase sintering.

12. The method of claim 10, wherein the magnesium, the aluminum and the tin are in the form of an alloy powder.

13. The method of claim 10, wherein the magnesium, the aluminum and the tin are mixed together to form a powder mixture.

14. The method of claim 10, wherein the magnesium, the aluminum and the tin are combined in any combination of alloy and elemental powders.

15. The method of claim 10, wherein the amount of magnesium is between about 2.5% to 4% by weight of the mixture.

16. The method of claim 10, wherein an amount of the tin is about 1% by weight of the mixture.

17. The method of claim 10, wherein full densification of the alloy is achieved for a liquid phase fraction greater than about 8%.

18. The method of claim 10, wherein the aluminum powder is an alloy of aluminum.

19. An alloy for liquid phase sintering in binder jet printing, the alloy comprising:
a mixture of:
aluminum;
tin; and
magnesium,
wherein an amount of the tin is about 1% by weight of the mixture and an amount of the magnesium is between about 2.5% to 6.5% by weight of the mixture, and wherein the remainder of the mixture is aluminum.

20. The alloy of claim 19, wherein the magnesium, the aluminum and the tin are combined in any combination of alloy and elemental powders.
